(19) United States
(12) Patent Application Publication
(10) Pub. No.: US 2026/0217029 A1
(43) Pub. Date: Jul. 30, 2026

(54) LIQUID EJECTION HEAD AND MANUFACTURING METHOD OF LIQUID EJECTION HEAD

(71) Applicant: CANON KABUSHIKI KAISHA, Tokyo (JP)

(72) Inventors: ZENTARO TAMENAGA, Kanagawa (JP); TAKESHI SHIBATA, Kanagawa (JP); SATOSHI IBE, Kanagawa (JP)

(21) Appl. No.: 19/453,166

(22) Filed: Jan. 20, 2026

(30) Foreign Application Priority Data
Jan. 29, 2025 (JP) 2025-012936

(51) Int. Cl. B41J 2/16; B41J 2/14

(52) U.S. Cl. CPC B41J 2/1623; B41J 2/14201; B41J 2/1607; B41J 2002/14491

(57) ABSTRACT

A liquid ejection head includes: an element substrate including an electrode terminal; and an electric wiring substrate including a wiring portion electrically connected to the electrode terminal. The electrode terminal is arranged in an end portion of the element substrate, and in an end portion region between the electrode terminal in the element substrate and an end portion of the element substrate, an insulating member is arranged between the end portion region and the electric wiring substrate.

### BACKGROUND

### Field of the Technology

The present disclosure relates to a liquid ejection head and a manufacturing method of the liquid ejection head.

### Description of The Related Art

Among liquid ejection heads, there is a liquid ejection head that includes an element substrate and an electric wiring substrate electrically connected to the element substrate. Japanese Patent Laid-Open No. 2021-054066 describes a manufacturing method of a liquid ejection head including a step of electrically connecting an element substrate and a wiring substrate (electric wiring substrate) to each other. Specifically, a wiring portion of the electric wiring substrate is brought close to and into contact with an electrode terminal provided in the element substrate. Thereafter, a portion where the electrode terminal of the element substrate and the wiring portion of the electric wiring substrate are in contact with each other is covered with, for example, a sealing resin to be protected. This allows the element substrate and the electric wiring substrate to be electrically connected to each other without use of wires such as wire bonding. Accordingly, productivity of the liquid ejection head is improved.

### SUMMARY

An object of the present disclosure is to provide a liquid ejection head that can improve reliability of a portion where an element substrate and an electric wiring substrate are electrically connected to each other.

A liquid ejection head according to one aspect of the present disclosure includes: an element substrate including an electrode terminal; and an electric wiring substrate including a wiring portion electrically connected to the electrode terminal. The electrode terminal is arranged in an end portion of the element substrate, and in an end portion region between the electrode terminal in the element substrate and an end portion of the element substrate, an insulating member is arranged between the end portion region and the electric wiring substrate.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating a configuration of a liquid ejection apparatus;

FIG. 2 is a perspective diagram illustrating one of head units in a liquid ejection head;

FIG. 3 is a perspective diagram illustrating a configuration of a liquid ejection unit;

FIG. 4 is an exploded perspective diagram of the liquid ejection unit;

FIGS. 5A and 5B are diagrams for explaining an element substrate in a first embodiment;

FIG. 6 is an enlarged diagram illustrating a state where the element substrate and an electric wiring substrate are separated from each other;

FIG. 7 is an enlarged diagram illustrating a state where the element substrate and the electric wiring substrate are electrically connected to each other;

FIG. 8 is a cross-sectional diagram schematically illustrating the liquid ejection unit in the first embodiment;

FIG. 9 is a flowchart illustrating a manufacturing process of the liquid ejection apparatus;

FIGS. 10A and 10B are explanatory diagrams explaining the manufacturing process of the liquid ejection apparatus in the first embodiment;

FIGS. 11A and 11B are explanatory diagrams explaining a comparative example of the liquid ejection unit;

FIG. 12 is an explanatory diagram illustrating a case where an insulating member is thicker than electrode terminals in the liquid ejection unit of the first embodiment;

FIG. 13 is a cross-sectional diagram schematically illustrating the liquid ejection unit in a second embodiment;

FIGS. 14A and 14B are explanatory diagrams explaining the manufacturing process of the liquid ejection apparatus in the second embodiment;

FIGS. 15A and 15B are diagrams for explaining the element substrate in a third embodiment;

FIGS. 16A and 16B are diagrams for explaining the element substrate in a fourth embodiment; and

FIGS. 17A and 17B are schematic diagrams illustrating a modified example of the liquid ejection unit.

### DESCRIPTION OF THE EMBODIMENTS

Preferable embodiments of the present disclosure are explained below in detail with reference to the attached drawings. Note that the following embodiments do not limit matters of the present disclosure, and not all of combinations of features explained in the following embodiments are necessarily essential for solving means of the present disclosure. Note that the same configurations are explained while being denoted by the same signs.

### First Embodiment

### Configuration of Liquid Ejection Apparatus

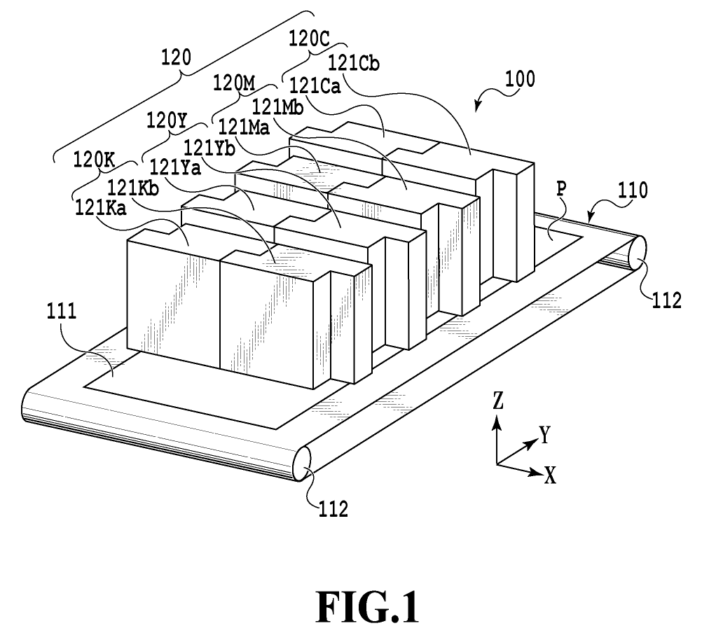

FIG. 1 is a diagram illustrating a configuration of a liquid ejection apparatus 100 according to the present embodiment. As illustrated in FIG. 1, the liquid ejection apparatus 100 includes a conveyance unit 110 and liquid ejection heads 120. The conveyance unit 110 conveys a print medium P in a conveyance direction. The liquid ejection heads 120 print an image on the print medium P by ejecting liquid (for example, inks) to the print medium P. In the present embodiment, a cut sheet is used as the print medium P.

Moreover, in FIGS. 1 to 16B, a z direction indicates the vertical direction, and intersects (is orthogonal to in the present embodiment) an X-Y plane defined by an X direction and a Y direction. As illustrated in FIG. 1, a -Y direction is the conveyance direction of the print medium P. A +Y direction is an opposite direction to the conveyance direction of the print medium P, in other words, a direction toward the upstream of the conveyance unit 110. A longitudinal direction (width direction) of the liquid ejection heads 120 is a direction along the X direction. A transverse direction (depth direction) of the liquid ejection heads 120 is a direction along the Y direction. A height direction of the liquid ejection heads 120 is a direction along the Z direction.

The conveyance unit 110 includes a conveyer belt 111, conveyance rollers 112, and a suction mechanism (not illustrated). The conveyer belt 111 holds the print medium P by causing the print medium P to adhere by using the suction mechanism. The conveyance rollers 112 turn the conveyer belt 111. Turning of the conveyer belt 111 by the conveyance rollers 112 conveys the print medium P held on the conveyer belt 111 by being adhering thereto, in the conveyance direction (-Y direction). The print medium P on which an image is printed by the liquid ejection heads 120 is separated from the conveyer belt 111 downstream of the conveyance unit 110 by a not-illustrated mechanism, and is discharged to a paper discharge unit (not illustrated).

The liquid ejection heads 120 are so-called page-wide type liquid ejection heads in which ejection ports are aligned to correspond to the width (length in the X direction) of the print medium P. The liquid ejection heads 120 include four liquid ejection heads 120C, 120M, 120Y, and 120K that are sequentially arranged along the conveyance direction from the upstream side of the conveyance unit 110 and that correspond to a cyan ink, a magenta ink, a yellow ink, and a black ink, respectively.

The liquid ejection head 120C corresponding to the cyan ink ejects the cyan ink by being supplied with the cyan ink. The liquid ejection head 120C corresponding to the cyan ink is formed by bonding a first head unit 121Ca arranged on the -X direction side and a second head unit 121Cb arranged on the +X direction side to each other. In the case where the first head unit 121Ca and the second head unit 121Cb corresponding to the cyan ink do not have to be particularly distinguished from each other, the first head unit 121Ca and the second head unit 121Cb are simply referred to as head units 121.

The liquid ejection head 120M corresponding to the magenta ink ejects the magenta ink by being supplied with the magenta ink. The liquid ejection head 120M corresponding to the magenta ink is formed by bonding a first head unit 121Ma arranged on the -X direction side and a second head unit 121Mb arranged on the +X direction side to each other. In the case where the first head unit 121Ma and the second head unit 121Mb corresponding to the magenta ink do not have to be particularly distinguished from each other, the first head unit 121Ma and the second head unit 121Mb are simply referred to as head units 121.

The liquid ejection head 120Y corresponding to the yellow ink ejects the yellow ink by being supplied with the yellow ink. The liquid ejection head 120Y corresponding to the yellow ink is formed by bonding a first head unit 121Ya arranged on the -X direction side and a second head unit 121Yb arranged on the +X direction side to each other. In the case where the first head unit 121Ya and the second head unit 121Yb corresponding to the yellow ink do not have to be particularly distinguished from each other, the first head unit 121Ya and the second head unit 121Yb are simply referred to as head units 121.

The liquid ejection head 120K corresponding to the black ink ejects the black ink by being supplied with the black ink. The liquid ejection head 120K corresponding to the black ink is formed by bonding a first head unit 121Ka arranged on the -X direction side and a second head unit 121Kb arranged on the +X direction side to each other. In the case where the first head unit 121Ka and the second head unit 121Kb corresponding to the black ink do not have to be particularly distinguished from each other, the first head unit 121Ka and the second head unit 121Kb are simply referred to as head units 121.

The liquid ejection head 120C corresponding to the cyan ink, the liquid ejection head 120M corresponding to the magenta ink, the liquid ejection head 120Y corresponding to the yellow ink, and the liquid ejection head 120K corresponding to the black ink are similarly configured. In the case where the four liquid ejection heads 120C, 120M, 120Y, and 120K corresponding to the cyan ink, the magenta ink, the yellow ink, and the black ink do not have to be particularly distinguished from one another, the liquid ejection heads 120C, 120M, 120Y, and 120K are simply referred to as liquid ejection heads 120. The liquid ejection heads 120 according to the present embodiment can perform full-color printing by ejecting the cyan ink, the magenta ink, the yellow ink, and the black ink to the print medium P conveyed by the conveyance unit 110.

### Configuration of Liquid Ejection Head

Next, the liquid ejection heads 120 according to the present embodiment are explained. For example, assume a case where an electric wiring substrate is tilted with respect to an element substrate in the case where the element substrate and the electric wiring substrate are electrically connected to each other. In this case, since the distance between the element substrate and the electric wiring substrate is small, a wiring portion of the electric wiring substrate sometimes comes into contact with the element substrate. As a result, there is a possibility that contact failure or the like occurs in, for example, a portion where an electrode terminal of the element substrate and the wiring portion of the electric wiring substrate come into contact with each other. In the present embodiment, explanation is given of a configuration that can improve reliability of a portion where the element substrate and the electric wiring substrate are electrically connected to each other.

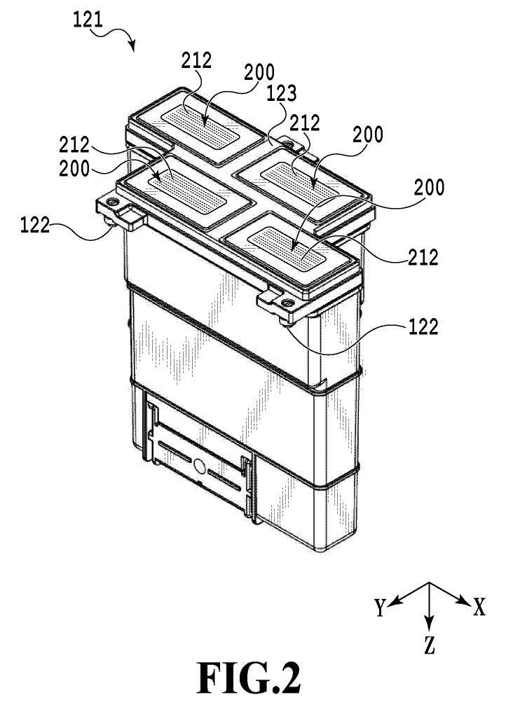

FIG. 2 is a perspective diagram illustrating one of the head units in the liquid ejection heads 120 according to the present embodiment. As illustrated in FIG. 2, each of the head units 121 of the liquid ejection heads 120 includes a reference member 122, multiple liquid ejection units 200, and a common support member 123. The reference member 122 has a function of positioning the liquid ejection head 120 with respect to the liquid ejection apparatus 100. Causing the reference member 122 to engage with an engagement portion (not illustrated) of the liquid ejection apparatus 100 causes the liquid ejection head 120 to be positioned with respect to the liquid ejection apparatus 100. The liquid ejection units 200 have a function of ejecting the liquid. The common support member 123 supports multiple (for example, four) liquid ejection units 200.

In the present embodiment, the four liquid ejection units 200 are arranged in staggered arrangement on the common support member 123. About 1,000 ejection ports 212 are formed in each liquid ejection unit 200. The liquid ejection unit 200 can print an image with resolution of 1,200 dpi by ejecting the liquid (ink) from the ejection ports 212.

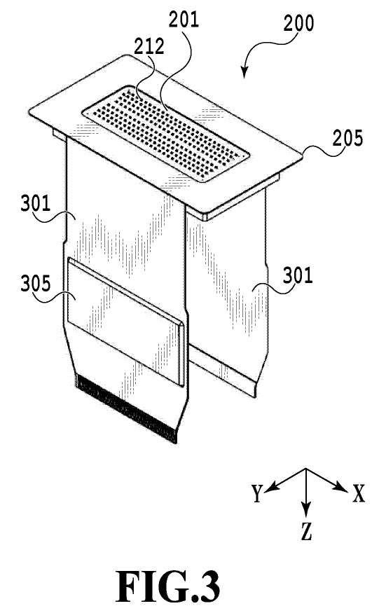

FIG. 3 is a perspective diagram illustrating a detailed configuration of the liquid ejection unit 200. As illustrated in FIG. 3, the liquid ejection unit 200 includes one element substrate 201 and two electric wiring substrates 301. The element substrate 201 includes the ejection ports 212 for ejecting the liquid (ink), a liquid flow passage (not illustrated), energy generation elements (not illustrated), and the like. The energy generation elements generate energy for ejecting the liquid from the ejection ports 212. In the present embodiment, piezoelectric elements are used as the energy generation elements. Moreover, the liquid ejection unit 200 includes a support member 205 for reinforcing the element substrate 201. The support member 205 is bonded to the ejection surface side of the element substrate 201 on which the ejection ports 212 are formed.

Each of the electric wiring substrate 301 is electrically connected to the element substrate 201. Examples of the electric wiring substrate 301 include a flexible printed circuit (FPC), a tape automated bonding (TAB) tape, and the like. A drive circuit substrate 305 for driving the energy generation elements of the element substrate 201 are provided in the electric wiring substrate 301.

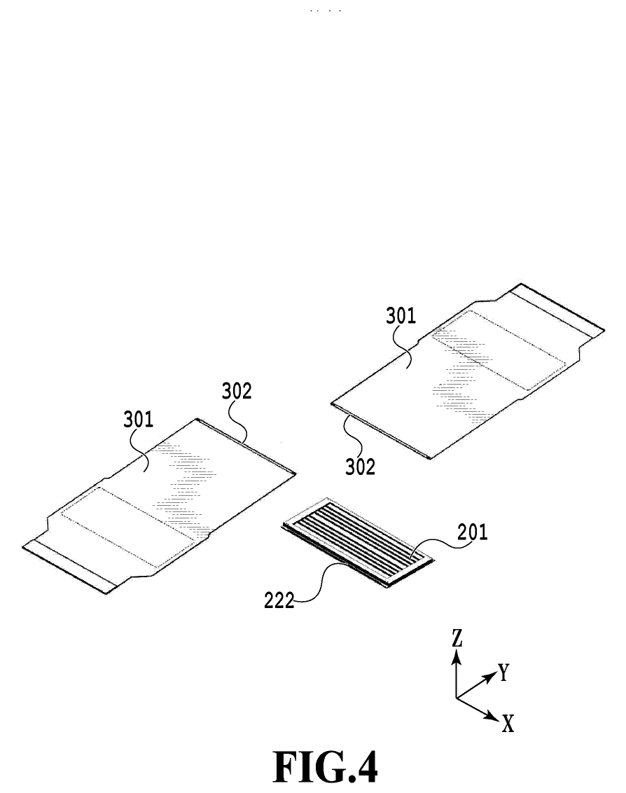

FIG. 4 is an exploded perspective diagram of the liquid ejection unit 200. As illustrated in FIG. 4, multiple electrode terminals 222 aligned along a longitudinal direction (X direction) of the element substrate 201 are provided in each of ±Y direction end portions of the element substrate 201. One end portion of each electric wiring substrate 301 is provided with an electric connection portion 302 extending along a transverse direction (X direction) of the electric wiring substrate 301. Multiple conductors (for example, wiring containing copper and nickel) are exposed in a pad shape in the electric connection portion 302, and function as connection regions connectable to the electrode terminals 222. Bringing the electric connection portion 302 into contact with the electrode terminals 222 electrically connects the element substrate 201 and the electric wiring substrate 301 to each other.

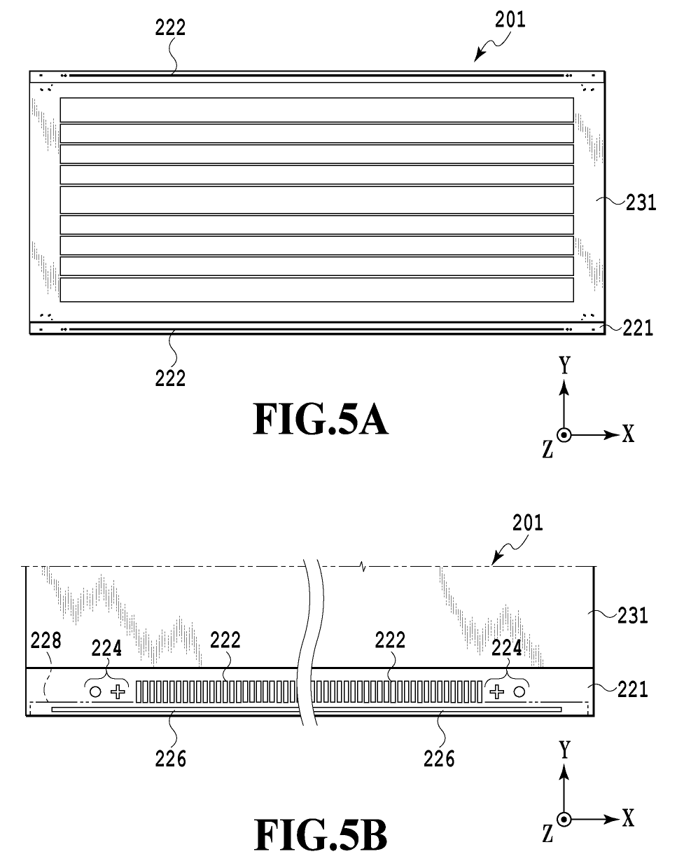

FIGS. 5A and 5B are diagrams for explaining the element substrate 201 in the first embodiment. FIG. 5A is an overall diagram of the element substrate 201. FIG. 5B is an enlarged diagram illustrating a portion near the -Y direction side end of the element substrate 201.

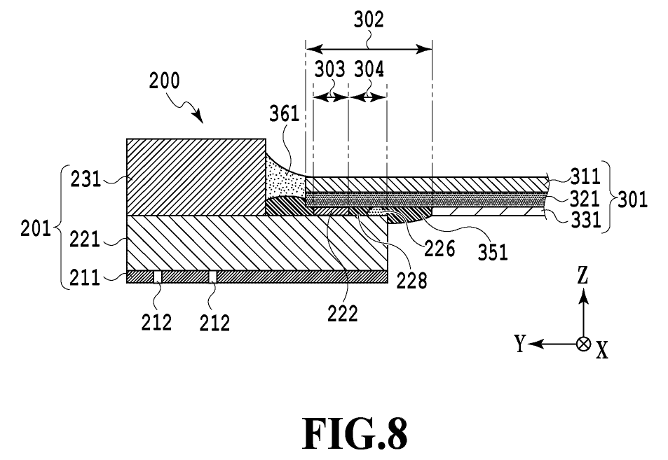

As illustrated in FIG. 5A, the element substrate 201 includes an ejection port forming substrate 211 (see FIG. 8 to be described later), an actuator substrate 221, and a flow passage forming substrate 231. The ejection port forming substrate 211 is formed in a plate shape elongating in the X direction. In the ejection port forming substrate 211, about 1,000 ejection ports 212 (see FIG. 8 to be described later) are formed as described above. The actuator substrate 221 is formed in a plate shape matching an outer peripheral shape of the ejection port forming substrate 211. The actuator substrate 221 is stacked on a +Z direction side surface of the ejection port forming substrate 211. The multiple energy generation elements (piezoelectric elements) corresponding to the multiple ejection ports 212 of the ejection port forming substrate 211 are formed in the actuator substrate 221. The flow passage forming substrate 231 is formed in a plate shape whose length in the Y direction is smaller than that of the actuator substrate 221. The flow passage forming substrate 231 is stacked on a +Z direction side surface of the actuator substrate 221. The liquid flow passage (not illustrated) communicating with the multiple ejection ports 212 of the ejection port forming substrate 211 is formed in the flow passage forming substrate 231. Note that the +Z direction side surface of the actuator substrate 221 in each of ±Y direction end portions is not covered with the flow passage forming substrate 231.

As illustrated in FIG. 5B, the multiple electrode terminals 222, first alignment marks 224, and an insulating member 226 are provided in each of the ±Y direction end portions of the actuator substrate 221. The multiple electrode terminals 222 are arranged to be aligned along the longitudinal direction (X direction) of the element substrate 201 (actuator substrate 221) in each of the ±Y direction end portions of the actuator substrate 221. Electric power is supplied from the electrode terminals 222 to the energy generation elements (piezoelectric elements). The first alignment marks 224 are arranged near and on lateral sides of the electrode terminals 222 in the end portion of the actuator substrate 221. For example, the first alignment marks 224 are formed by aligning a plus (+) mark and a circle (○) mark along the end portions of the actuator substrate 221.

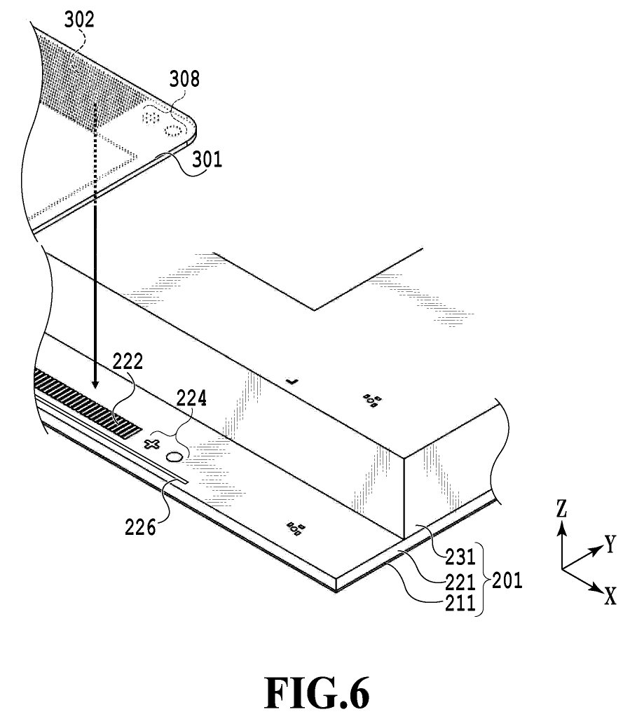

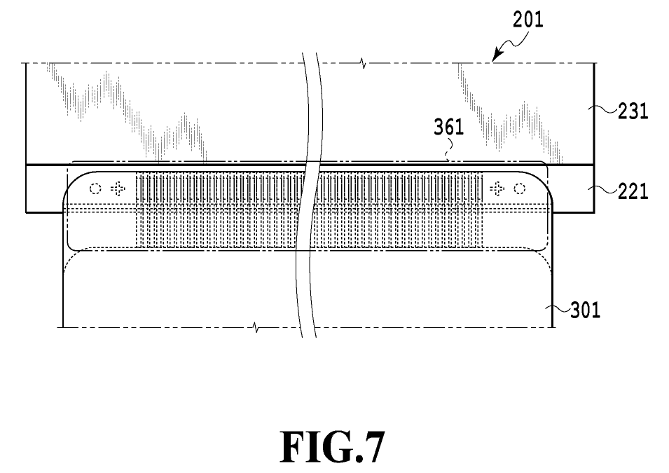

FIG. 6 is an enlarged diagram illustrating a state where the element substrate 201 and the electric wiring substrate 301 are separated from each other. FIG. 7 is an enlarged diagram illustrating a state where the element substrate 201 and the electric wiring substrate 301 are electrically connected to each other. As illustrated in FIG. 6, second alignment marks 308 are provided near and on the lateral sides of the electric connection portion 302 in the end portion of the electric wiring substrate 301. The second alignment marks 308 are formed to have the same shape as the first alignment marks 224, and are configured to position-match with the first alignment marks 224. The first alignment marks 224 and the second alignment marks 308 are used as reference of alignment in the case where the element substrate 201 and the electric wiring substrate 301 are electrically connected to each other. Matching the first alignment marks 224 and the second alignment marks 308 with on another allows the electric connection portion 302 (conductor) of the electric wiring substrate 301 to be accurately aligned with the electrode terminals 222 of the element substrate 201 as illustrated in FIGS. 6 and 7.

As described above, the element substrate 201 according to the present embodiment includes the piezoelectric elements as the energy generation elements for ejecting the liquid (ink) from the ejection ports 212. A relatively large number of electrode terminals 222 for supplying electric power to the multiple energy generation elements (piezoelectric elements) are provided in the element substrate 201 that ejects the liquid in a piezoelectric method. Accordingly, an interval between two adjacent electrode terminals 222 is relatively small. In the present embodiment, matching the first alignment marks 224 and the second alignment marks 308 with one another enables highly-accurate alignment. Accordingly, the electric connection portion 302 of the electric wiring substrate 301 can be properly connected to the electrode terminals 222 of the element substrate 201.

Note that, although the first alignment marks 224 and the second alignment marks 308 are formed by aligning the plus (+) mark and the circle (○) mark, the first alignment marks 224 and the second alignment marks 308 are not limited to this. The first alignment marks 224 and the second alignment marks 308 only need to be highly-recognizable marks. For example, the first alignment marks 224 and the second alignment marks 308 preferably have color tones and shapes that are unlikely to be erroneously recognized. The first alignment marks 224 and the second alignment marks 308 preferably each have a shape whose center of gravity is easily recognizable.

As illustrated in FIGS. 5B and 6, the insulating member 226 is formed in an end portion region 228 provided between the electrode terminals 222 in the element substrate 201 (actuator substrate 221) and the end portion of the element substrate 201. For example, the insulating member 226 is formed to linearly extend along the end portion of the element substrate 201 (actuator substrate 221) by using a thermosetting adhesive. Note that the material of the insulating member 226 is not limited to the adhesive, and may be any material with an insulating property. For example, the insulating member 226 may be formed by using the same non-conductive resin as a resin member 351 to be described later. The insulating member 226 may be formed by using the same material as an insulating film formed in a step of producing the element substrate 201 by using a semiconductor manufacturing process.

FIG. 8 is a cross-sectional diagram schematically illustrating the liquid ejection unit 200 in the first embodiment. FIG. 8 illustrates a positional relationship between the electric connection portion 302 of the electric wiring substrate 301 and the electrode terminals 222 of the element substrate 201.

As illustrated in FIG. 8, the electric wiring substrate 301 includes a base portion 311, a wiring portion 321, and a cover portion 331. The base portion 311 is formed in a film shape by using a resin material such as polyimide. The wiring portion 321 is formed on a surface of the base portion 311 by using a metal material containing copper, nickel, and the like. The cover portion 331 is formed on surfaces of the base portion 311 and the wiring portion 321 by using a solder resist. Note that, in an end portion of the electric wiring substrate 301, an end portion of the wiring portion 321 is exposed to form the electric connection portion 302. The wiring portion 321 in the electric connection portion 302 of the electric wiring substrate 301 includes a connection region 303 connected to the electrode terminals 222 of the element substrate 201 and a facing region 304 facing the end portion region 228 of the element substrate 201. In the example illustrated in FIG. 8, the facing region 304 is adjacent to and on the -Y direction side of the connection region 303. The connection region 303 faces the multiple electrode terminals 222 aligned in the end portion of the actuator substrate 221 in the element substrate 201, and is connected to these electrode terminals 222.

Electrical connection between the electrode terminals 222 of the element substrate 201 and the electric connection portion 302 (wiring portion 321) of the electric wiring substrate 301 enables supply of energy and electric signals for ejection of the liquid from the electric wiring substrate 301 to the element substrate 201. Then, the element substrate 201 can eject the liquid from the ejection ports 212 by performing power conduction and communication with the outside of the liquid ejection unit 200 via the electric wiring substrate 301.

Moreover, the liquid ejection unit 200 includes the resin member 351 and a sealing material 361. The resin member 351 maintains a state where the electrode terminals 222 of the element substrate 201 and the electric connection portion 302 (wiring portion 321) of the electric wiring substrate 301 are electrically connected to each other. The resin member 351 is formed by using a non-conductive resin such as, for example, a non-conductive paste (NCP). The resin member 351 is arranged around the electrode terminals 222 of the element substrate 201 electrically connected to the electric connection portion 302 of the electric wiring substrate 301.

The sealing material 361 is applied over the resin member 351 (see also FIG. 7). The sealing material 361 preferably has a stiffness capable of protecting a portion where the element substrate 201 and the electric wiring substrate 301 are electrically connected to each other from external force. Moreover, the sealing material 361 is preferably capable of suppressing corrosion caused by the liquid for ejection, moisture in the environment, and the like. For example, an epoxy resin or the like is given as the material of the sealing material 361. Note that the material of the sealing material 361 is not limited to the epoxy resin. The sealing material 361 may contain various materials depending on required performances.

In the present embodiment, the piezoelectric elements (not illustrated) are formed in the actuator substrate 221 in the element substrate 201, as the energy generation elements. Each of the piezoelectric elements is configured to include an upper electrode film (not illustrated), a piezoelectric layer (not illustrated), and a lower electrode film (not illustrated). In the case where signals are supplied from the wiring portion 321 of the electric wiring substrate 301 to the actuator substrate 221 via the electrode terminals 222, the volumes of the piezoelectric elements change, and droplets (ink droplets) are ejected from the ejection ports 212 of the ejection port forming substrate 211.

In the element substrate 201 of the piezoelectric method, the flow passage is divided into individual flow passages as many as the number of ejection ports 212 from which the droplets are ejected, and the piezoelectric elements are provided in the respective individual flow passages. In the case where the ejection ports 212 are to be formed at a higher density without changing the dimensions and the like of the element substrate 201, the number of piezoelectric elements needs to be increased. The number of necessary electrode terminals 222 also increases with the increase in the number of piezoelectric elements, and the number of electrodes also increases. As described above, the electric connection portion 302 of the electric wiring substrate 301 can be accurately aligned with the electrode terminals 222 of the element substrate 201 by matching the first alignment marks 224 and the second alignment marks 308 with one another. Accordingly, it is possible to precisely connect the electric connection portion 302 of the electric wiring substrate 301 to the electrode terminals 222 of the element substrate 201.

Moreover, in the present embodiment, the insulating member 226 is arranged between the end portion region 228 in the element substrate 201 and the facing region 304 in the wiring portion 321 of the electric wiring substrate 301. Even if the electric wiring substrate 301 is tilted with respect to the element substrate 201 in the case where the electric connection portion 302 of the electric wiring substrate 301 is brought close to the electrode terminals 222 of the element substrate 201, the wiring portion 321 (facing region 304) of the electric wiring substrate 301 abuts the insulating member 226. The insulating member 226 formed on the actuator substrate 221 makes the wiring portion 321 of the electric wiring substrate 301 less likely to come into contact with the actuator substrate 221. This can suppress occurrence of contact failure and the like caused by the wiring portion 321 of the electric wiring substrate 301 coming into contact with the actuator substrate 221 in the element substrate 201 in the case where the element substrate 201 and the electric wiring substrate 301 are electrically connected to each other.

### Manufacturing Method of Liquid Ejection Head

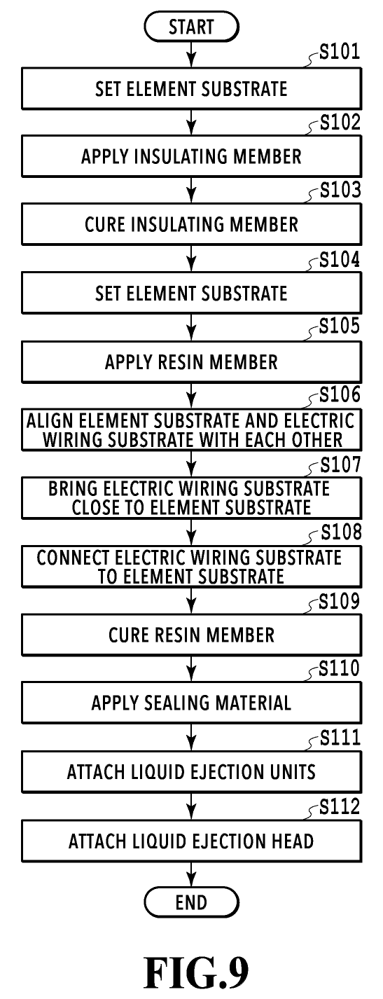

Next, a manufacturing method of the liquid ejection head 120 and the liquid ejection apparatus 100 according to the present embodiment is explained. FIG. 9 is a flowchart illustrating a manufacturing process of the liquid ejection apparatus 100 in the present embodiment. Note that sign "S" in explanation of each step means step in the flowchart.

In S101, the element substrate 201 is set. In this case, the element substrate 201 prepared in advance is placed in an operation region of a coating machine (not illustrated) that applies the pre-cured (liquid-state) insulating member 226. For example, a worker may manually place the element substrate 201 in the operation region of the coating machine. The configuration may be such that the worker or a conveyance robot places the element substrate 201 on a predetermined temporal placing stage, and then a robot hand provided in the coating machine conveys the element substrate 201 placed on the temporal placing stage to the operation region. After completion of the step of S101, the step of S102 is performed.

In S102, the coating machine is used to apply the pre-cured insulating member 226 to each of the end portion regions 228 between the electrode terminals 222 in the element substrate 201 and the end portions of the element substrate 201. Note that the coating machine is an apparatus that draws a desired figure or the like by ejecting liquid-state adhesive, sealing material, or the like filled in a syringe by using air pressure. The coating machine is also referred to as dispenser. After completion of the step S102, the step of S103 is performed.

In S103, the insulating member 226 applied in S102 is cured to fix the shape of the insulating member 226. In the case where the insulating member 226 is formed by using a thermosetting adhesive (or the NCP described above), the insulating member 226 is cured by being heated. After completion of the step of S103, the step of S104 is performed.

In S104, the element substrate 201 on which the insulating member 226 is formed is set. In this case the element substrate 201 on which the insulating member 226 is formed is placed in an operation region of a coating machine (not illustrated) that applies the pre-cured (liquid-state) resin member 351. Note that the element substrate 201 is placed in the operation region of the coating machine that applies the resin member 351 as in the case of the coating machine that applies the insulating member 226. After completion of the step of S104, the step of S105 is performed.

In S105, the coating machine is used to apply the pre-cured resin member 351 at the electrode terminals 222 of the element substrate 201 and around the electrode terminals 222. After completion of the step of S105, the step of S106 is performed.

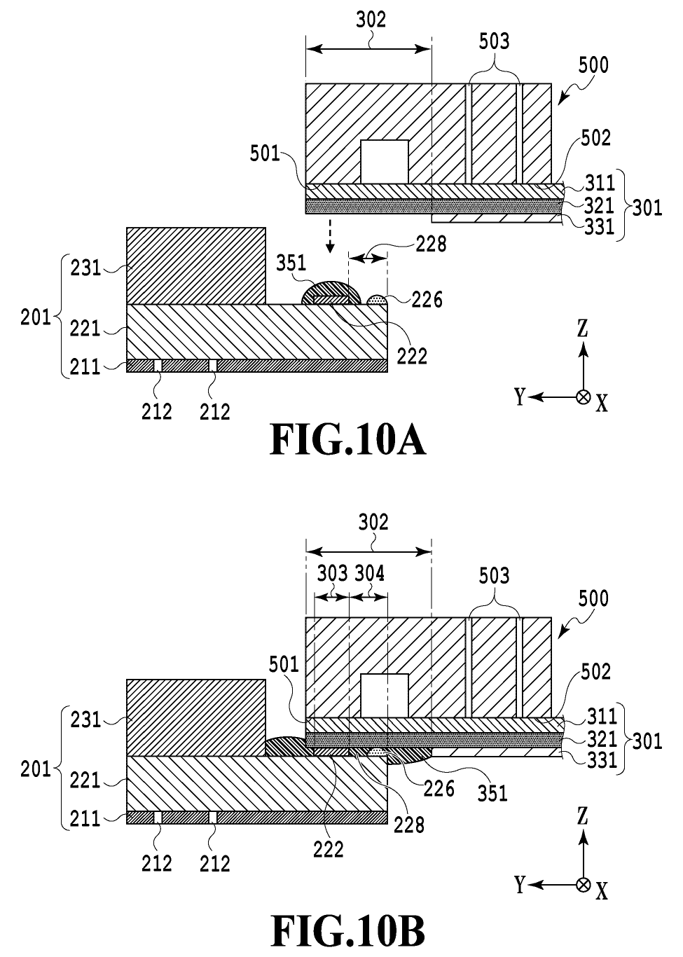

In S106, the element substrate 201 and each electric wiring substrate 301 are aligned with each other. In this case, a camera (not illustrated) is used to obtain an image of the first alignment marks 224 in the element substrate 201 and an image of the second alignment marks 308 in the electric wiring substrate 301. Image processing is performed on the images obtained by using the camera to recognize the positions of the first alignment marks 224 and the second alignment marks 308. Then, a bonding tool 500 (see FIG. 10A to be described later) is used to move the electric wiring substrate 301 prepared in advance such that the first alignment marks 224 and the second alignment marks 308 match one another. The electric connection portion 302 of the electric wiring substrate 301 can be thereby accurately aligned with the electrode terminals 222 of the element substrate 201. Note that the image of the second alignment marks 308 in the electric wiring substrate 301 is obtained in a state where the electric wiring substrate 301 is held by the bonding tool 500 by adhering thereto. After completion of the step of S106, the step of S107 is performed.

In S107, the bonding tool 500 is used to bring the electric wiring substrate 301 close to the element substrate 201. In this case, the electric connection portion 302 of the electric wiring substrate 301 held by the bonding tool 500 by adhering thereto are brought close to the surface of the element substrate 201 provided with the electrode terminals 222 with the electric connection portion 302 maintained substantially parallel to the surface provided with the electrode terminals 222. After completion of the step of S107, the step of S108 is performed.

FIGS. 10A and 10B are explanatory diagrams explaining the manufacturing process of the liquid ejection apparatus 100 in the first embodiment. FIG. 10A is an explanatory diagram explaining the step of bringing each of the electric wiring substrates 301 close to the element substrate 201. As illustrated in FIG. 10A, the bonding tool 500 holds the electric wiring substrate 301 by causing the electric wiring substrate 301 to adhere, before execution of the step of bringing the electric wiring substrate 301 close to the element substrate 201. The bonding tool 500 is attached to a module (not illustrated) that presses the electric connection portion 302 of the electric wiring substrate 301 against the electrode terminals 222 of the element substrate 201. The module that presses the electric connection portion 302 of the electric wiring substrate 301 may be provided in the coating machine that applies the resin member 351.

The bonding tool 500 includes a pressing surface 501, an adhesion surface 502, and a sucking portion 503. Moreover, a heating heater (not illustrated) that heats the bonding tool 500 is included in the bonding tool 500. The heating heater can heat the bonding tool 500 to desired setting temperature by performing temperature control. The pressing surface 501 is formed near a distal end of a lower (-Z direction side) surface of the bonding tool 500. The pressing surface 501 can press the electric connection portion 302 (connection region 303) of the electric wiring substrate 301 against the electrode terminals 222 of the element substrate 201 at constant setting load by performing load control of the module to which the bonding tool 500 is attached. Moreover, the pressing surface 501 can use the heating heater to heat and cure the resin member 351 arranged around the electrode terminals 222 of the element substrate 201 electrically connected to the electric connection portion 302 of the electric wiring substrate 301.

The adhesion surface 502 is formed adjacent to a base end portion of the pressing surface 501 in the lower surface of the bonding tool 500. The sucking portion 503 that sucks the electric wiring substrate 301 is provided in a portion of the bonding tool 500 where the adhesion surface 502 is formed. The adhesion surface 502 can hold the electric wiring substrate 301 by causing the electric wiring substrate 301 to adhere by using the sucking portion 503. Note that the adhesion surface 502 is formed at the same height position as the pressing surface 501.

In the case where the wiring portion 321 of the electric wiring substrate 301 comes into contact with the actuator substrate 221 in the element substrate 201, there is a possibility that a current flows between multiple electrode terminals 222 provided in the actuator substrate 221. Moreover, in the case where the distance between the wiring portion 321 of the electric wiring substrate 301 and the actuator substrate 221 is small, there is a possibility that insulation breakdown occurs in the insulating member 226, and a current flows between multiple electrode terminals 222. In the present embodiment, the distance between the wiring portion 321 of the electric wiring substrate 301 and the actuator substrate 221 is set to 2 μm or more to prevent flowing of a current between multiple electrode terminals 222.

Moreover, it is difficult to make the thickness of the insulating member 226 as small as possible. For example, in the case where the thickness of the electrode terminals 222 is smaller than 2 μm, there is a possibility that the thickness of the insulating member 226 is larger than the thickness of the electrode terminals 222. In the present embodiment, the thickness of the electrode terminals 222 is set to 2 μm, and the thickness of the insulating member 226 is set to 2 μm or more and 10 μm or less. Moreover, the width of the insulating member 226 in the Y direction (direction from the electrode terminals 222 toward the end of the actuator substrate 221) is set to 100 μm or less.

Returning to FIG. 9, in S108, the bonding tool 500 is used to connect the electric wiring substrate 301 to the element substrate 201. In this case, the wiring portion 321 (electric connection portion 302) of the electric wiring substrate 301 is connected to the electrode terminals 222 of the element substrate 201. The connection region 303 of the electric connection portion 302 is pressed by the pressing surface 501 of the bonding tool 500 while being in contact with the electrode terminals 222 of the element substrate 201. Note that the resin member 351 applied to the electrode terminals 222 of the element substrate 201 is pressed by the electric connection portion 302 (connection region 303) of the electric wiring substrate 301, and spreads to an area around the electrode terminals 222. After completion of the step of S108, the step of S109 is performed.

Note that the surface of the electric wiring substrate 301 to face the element substrate 201 is preferably subjected to hydrophilic treatment before execution of the step of connecting the electric wiring substrate 301 to the element substrate 201. Since the hydrophilic treatment improves wettability of the surface of the electric wiring substrate 301 to face the element substrate 201, the pre-cured resin member 351 is more likely to wet and spread on the surface of the electric wiring substrate 301 to face the element substrate 201. Accordingly, the pre-cured resin member 351 can be suppressed from dripping from the electric wiring substrate 301 and flowing into the ejection ports 212. Note that the process for suppressing dripping of the resin member 351 is not limited to the hydrophilic treatment.

In S109, the resin member 351 is cured. In this case, heating temperature and heating time for the resin member 351 are set according to curing properties of the resin member 351. In the case where the resin member 351 is heated by using the bonding tool 500, curing shrinkage force is generated in the resin member 351, and the resin member 351 is cured. In the case where the resin member 351 is cured, the bonding tool 500 is separated from the electric wiring substrate 301. Then, the cured resin member 351 maintains the state where the electrode terminals 222 of the element substrate 201 and the electric connection portion 302 (wiring portion 321) of the electric wiring substrate 301 are electrically connected to one another. After completion of the step S109, the step of S110 is performed.

FIG. 10B is an explanatory diagram explaining the step of curing the resin member 351. As illustrated in FIG. 10B, in the case where the step of curing the resin member 351 is executed, the resin member 351 spreads around the electrode terminals 222 in the actuator substrate 221. In the case where the resin member 351 is heated by using the bonding tool 500, the resin member 351 is cured, and the shape of the resin member 351 is fixed. The electric connection portion 302 of the electric wiring substrate 301 is fixed to the electrode terminals 222 of the actuator substrate 221 by the cured resin member 351 also after the separation of the bonding tool 500 from the electric wiring substrate 301. Note that the heating temperature and the heating time necessary for the curing of the resin member 351 are set depending on materials contained in the resin member 351.

In S110, the sealing material 361 is applied onto the resin member 351 by using a coating machine. The liquid ejection unit 200 is finished by performing the steps up to S110. After completion of the step of S110, the step of S111 is performed.

In S111, the liquid ejection unit 200 is attached to the common support member 123 (see FIG. 2) of the liquid ejection head 120. The liquid ejection head 120 is finished by performing the steps up to S111. After completion of the step of S111, the step of S112 is performed.

In S112, the liquid ejection head 120 is attached to a predetermined position in the liquid ejection apparatus 100. In this case, the reference member 122 (see FIG. 2) of the liquid ejection head 120 is made to engage with the engagement portion (not illustrated) of the liquid ejection apparatus 100. The liquid ejection apparatus 100 is completed by performing the steps up to S112. That is explanation of the flowchart illustrating the manufacturing process of the liquid ejection apparatus 100.

### Comparative Example

Next, a comparative example of the liquid ejection unit is explained. The liquid ejection unit in the comparative example is configured similar to the liquid ejection unit 200 of the first embodiment except for the point that no insulating member 226 is provided. Accordingly, individual members in the comparative example are denoted by the same signs as the members in the first embodiment, and detailed explanation thereof is omitted.

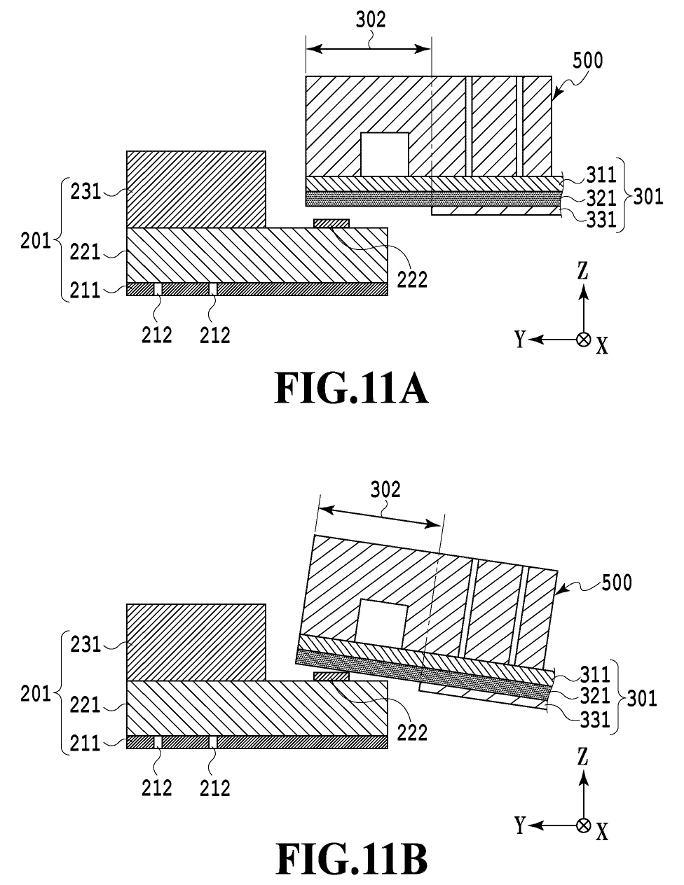

FIGS. 11A and 11B are explanatory diagrams explaining the comparative example of the liquid ejection unit. FIG. 11A is an explanatory diagram explaining a state where the electric wiring substrate 301 is properly connected to the element substrate 201 in the comparative example. As illustrated in FIG. 11A, the bonding tool 500 holds the electric wiring substrate 301 parallel to the element substrate 201 to electrically connect the electric connection portion 302 of the electric wiring substrate 301 to the electrode terminals 222 of the element substrate 201. Note that, in FIGS. 11A and 11B, illustration of the resin member 351 is omitted to facilitate explanation.

FIG. 11B is an explanatory diagram explaining a state where the electric wiring substrate 301 is not properly connected to the element substrate 201 in the comparative example. In the case where the bonding tool 500 is tilted while holding the electric wiring substrate 301 as illustrated in FIG. 11B, there is a possibility that the electric connection portion 302 (wiring portion 321) of the electric wiring substrate 301 comes into contact with the actuator substrate 221 in the element substrate 201. As described above, in the case where the wiring portion 321 of the electric wiring substrate 301 comes into contact with the actuator substrate 221 in the element substrate 201, there is a possibility that a current flows between multiple electrode terminals 222 provided in the actuator substrate 221. Moreover, there is a possibility that contact failure or the like occurs in the portion where the electrode terminals 222 of the element substrate 201 and the electric connection portion 302 (wiring portion 321) of the electric wiring substrate 301 come into contact with one another.

Meanwhile, in the present embodiment, the insulating member 226 is arranged between the end portion region 228 in the element substrate 201 and the facing region 304 in the wiring portion 321 of the electric wiring substrate 301. Even if the electric wiring substrate 301 is tilted with respect to the element substrate 201 in the case where the electric connection portion 302 of the electric wiring substrate 301 is brought close to the electrode terminals 222 of the element substrate 201, the wiring portion 321 (facing region 304) of the electric wiring substrate 301 abuts the insulating member 226. The insulating member 226 formed on the actuator substrate 221 makes the wiring portion 321 of the electric wiring substrate 301 less likely to come into contact with the actuator substrate 221. This can suppress a case where the wiring portion 321 of the electric wiring substrate 301 comes into contact with the actuator substrate 221 in the element substrate 201, and causes contact failure or the like in the step of connecting the electric wiring substrate 301 to the element substrate 201.

As explained above, according to the first embodiment, the reliability of the portion where the element substrate 201 and the electric wiring substrate 301 are electrically connected to each other can be improved. Specifically, in the present embodiment, in the end portion region 228 between the electrode terminals 222 in the element substrate 201 and the end portion of the element substrate 201, the insulating member 226 is arranged between the end portion region 228 and the electric wiring substrate 301. Even if the electric wiring substrate 301 is tilted with respect to the element substrate 201 in the case where the electric wiring substrate 301 is brought close to the element substrate 201, the wiring portion 321 (facing region 304) of the electric wiring substrate 301 abuts the insulating member 226. The insulating member 226 formed on the element substrate 201 makes the wiring portion 321 of the electric wiring substrate 301 less likely to come into contact with the element substrate 201. This can suppress the case where the wiring portion 321 of the electric wiring substrate 301 comes into contact with the element substrate 201, and causes contact failure or the like in the step of connecting the electric wiring substrate 301 to the element substrate 201. The reliability of the portion where the element substrate 201 and the electric wiring substrate 301 are electrically connected to each other can be improved as described above.

### Second Embodiment

Next, a second embodiment is explained. Since individual members in the second embodiment have configurations similar to those in the first embodiment described above, the individual members are explained while being denoted by the same signs as the members in the first embodiment described above. The liquid ejection head 120 according to the second embodiment is configured similarly to the liquid ejection head 120 according to the first embodiment except for the point that an inclined portion is formed in each electric wiring substrate 301. Explanation of portions of the second embodiment in common with the first embodiment is omitted as appropriate.

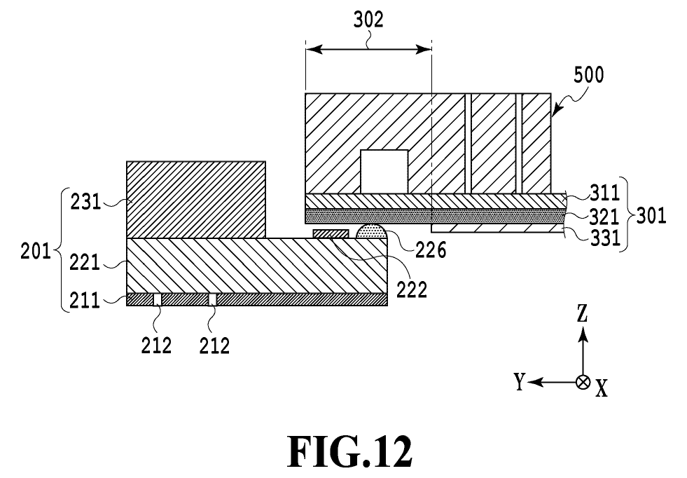

FIG. 12 is an explanatory diagram illustrating a case where the insulating member 226 is thicker than the electrode terminals 222 in the liquid ejection unit 200 of the first embodiment. In the case where the insulating member 226 is thicker than the electrode terminals 222, in the step of bringing the electric wiring substrate 301 close to the element substrate 201, there is a possibility that the electric connection portion 302 of the electric wiring substrate 301 comes into contact with the insulating member 226 before coming into contact with the electrode terminals 222. In the case where the electric wiring substrate 301 is attempted to be brought close to the element substrate 201 in the state where the electric connection portion 302 is in contact with the insulating member 226, there is a possibility that the insulating member 226 causes the electric wiring substrate 301 to be inclined. Accordingly, there is a possibility that misalignment occurs between the element substrate 201 and the electric wiring substrate 301 aligned in S106. Thus, in the step of bringing the electric wiring substrate 301 close to the element substrate 201, the electric connection portion 302 of the electric wiring substrate 301 is preferably brought into contact with the electrode terminals 222 before being brought into contact with the insulating member 226. Note that illustration of the resin member 351 is omitted in FIG. 12 to facilitate explanation.

### Configuration of Liquid Ejection Unit

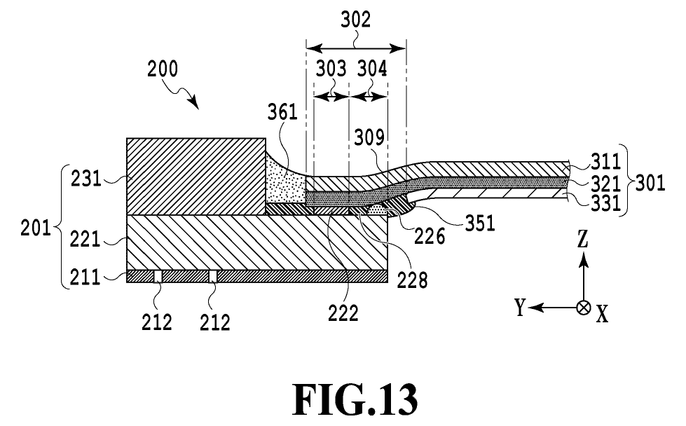

FIG. 13 is a cross-sectional diagram schematically illustrating the liquid ejection unit 200 in the second embodiment. FIG. 13 illustrates a positional relationship between the electric connection portion 302 of the electric wiring substrate 301 and the electrode terminals 222 of the element substrate 201. The liquid ejection unit 200 in the second embodiment includes the element substrate 201 and the electric wiring substrates 301 as in the first embodiment.

The electric wiring substrate 301 in the second embodiment includes the base portion 311, the wiring portion 321, and the cover portion 331 as in the first embodiment. In the end portion of the electric wiring substrate 301, the end portion of the wiring portion 321 is exposed to form the electric connection portion 302. The wiring portion 321 in the electric connection portion 302 of the electric wiring substrate 301 includes the connection region 303 connected to the electrode terminals 222 of the element substrate 201 and the facing region 304 facing the end portion region 228 of the element substrate 201. In the second embodiment, an inclined portion 309 that is inclined with respect to the connection region 303 is formed in a portion (electric connection portion 302) of the electric wiring substrate 301 where the facing region 304 is provided. The inclined portion 309 extends while being inclined in a direction away from the actuator substrate 221 in the element substrate 201, in other words, the opposite direction (+Z direction) to the end portion region 228 of the element substrate 201. The inclined portion 309 is formed by forming a bent in the electric wiring substrate 301.

Moreover, the liquid ejection unit 200 in the second embodiment includes the resin member 351 and the sealing material 361 as in the first embodiment. The resin member 351 in the second embodiment maintains a state where the electrode terminals 222 of the element substrate 201 and the electric connection portion 302 (wiring portion 321) of the electric wiring substrate 301 are electrically connected to one another. In the second embodiment, the resin member 351 maintains the shape of the inclined portion 309 formed in the electric connection portion 302 of the electric wiring substrate 301.

Moreover, in the second embodiment, the insulating member 226 is arranged between the end portion region 228 in the element substrate 201 and the facing region 304 in the wiring portion 321 of the electric wiring substrate 301. This can suppress the case where the wiring portion 321 of the electric wiring substrate 301 comes into contact with the actuator substrate 221 in the element substrate 201, and causes contact failure or the like in the case where the element substrate 201 and the electric wiring substrate 301 are electrically connected to each other as in the first embodiment.

### Manufacturing Method of Liquid Ejection Head

The liquid ejection heads 120 and the liquid ejection apparatus 100 according to the second embodiment are manufactured by a manufacturing method similar to that in the first embodiment. In the second embodiment, contents different from the first embodiment are explained.

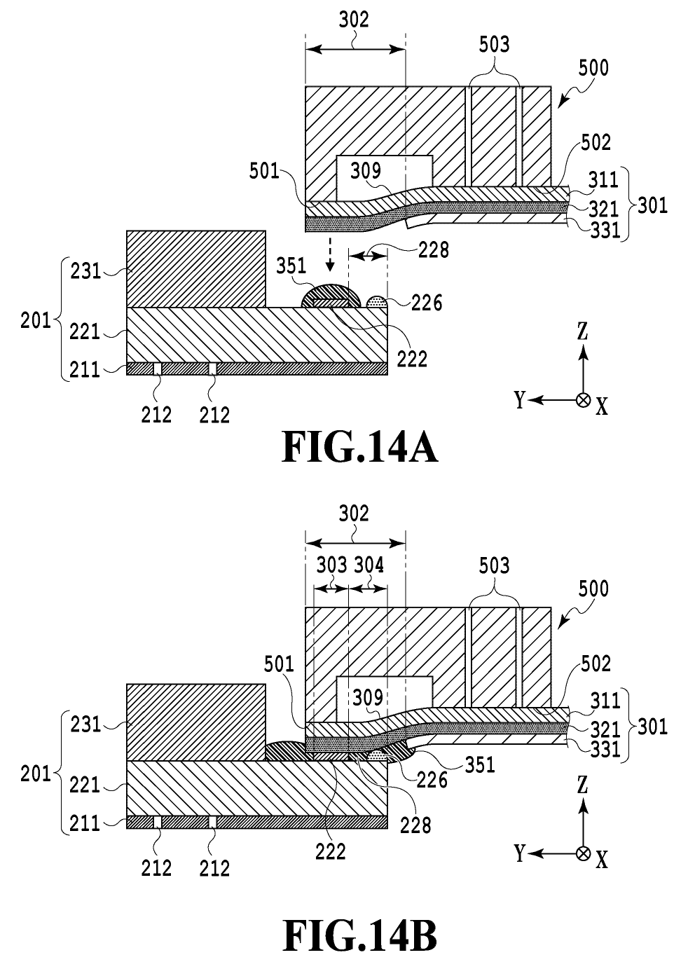

FIGS. 14A and 14B are explanatory diagrams explaining a manufacturing process of the liquid ejection apparatus 100 in the second embodiment. FIG. 14A is an explanatory diagram explaining the step of bringing the electric wiring substrate 301 close to the element substrate 201. As illustrated in FIG. 14A, the bonding tool 500 holds the electric wiring substrate 301 by causing the electric wiring substrate 301 to adhere, before execution of the step of bringing the electric wiring substrate 301 close to the element substrate 201. The bonding tool 500 in the second embodiment is attached to the module (not illustrated) that presses the electric connection portion 302 of the electric wiring substrate 301 against the electrode terminals 222 of the element substrate 201 as in the first embodiment.

The bonding tool 500 in the second embodiment includes the pressing surface 501, the adhesion surface 502, and the sucking portion 503 as in the first embodiment. Moreover, a heating heater (not illustrated) that heats the bonding tool 500 is included in the bonding tool 500 as in the first embodiment. The adhesion surface 502 in the second embodiment is formed at a position above the pressing surface 501 in the vertical direction. The adhesion surface 502 includes a horizontal surface portion (not illustrated) parallel to the pressing surface 501 and an inclined surface portion (not illustrated) that is inclined between the horizontal surface portion and the pressing surface 501. An inclination angle of the inclined surface portion in the adhesion surface 502 is set to, for example, 10 degrees. The inclination angle of the inclined surface portion in the adhesion surface 502 may be set to 10 degrees or less. The sucking portion 503 sucks the electric wiring substrate 301 in contact with the pressing surface 501 and the adhesion surface 502. The electric wiring substrate 301 sucked by the sucking portion 503 elastically deforms along the pressing surface 501 and the adhesion surface 502, and the inclined portion 309 is formed in the portion (electric connection portion 302) of the electric wiring substrate 301 where the facing region 304 is provided.

FIG. 14B is an explanatory diagram explaining the step of connecting the electric wiring substrate 301 to the element substrate 201. Even if the electric wiring substrate 301 is tilted with respect to the element substrate 201 in the case where the electric connection portion 302 of the electric wiring substrate 301 is brought close to the electrode terminals 222 of the element substrate 201, the wiring portion 321 of the electric wiring substrate 301 abuts with the insulating member 226. The insulating member 226 formed on the actuator substrate 221 makes the wiring portion 321 of the electric wiring substrate 301 less likely to come into contact with the actuator substrate 221. This can suppress the case where the wiring portion 321 of the electric wiring substrate 301 comes into contact with the actuator substrate 221 in the element substrate 201, and causes contact failure or the like in the step of connecting the electric wiring substrate 301 to the element substrate 201. Moreover, forming the inclined portion 309 in the portion (electric connection portion 302) of the electric wiring substrate 301 where the facing region 304 is provided causes the facing region 304 to be arranged while being inclined in the direction away from the insulating member 226. Accordingly, also in the case where the insulating member 226 is thicker than the electrode terminals 222, the electric connection portion 302 of the electric wiring substrate 301 can be brought into contact with the electrode terminals 222 before coming into contact with the insulating member 226 in the step of bringing the electric wiring substrate 301 close to the element substrate 201.

Moreover, in the case where the resin member 351 is heated by using the bonding tool 500 in the step of curing the resin member 351, the resin member 351 is cured, and the shape of the resin member 351 is fixed. The electric connection portion 302 of the electric wiring substrate 301 is fixed to the electrode terminals 222 of the actuator substrate 221 by the cured resin member 351 also after the separation of the bonding tool 500 from the electric wiring substrate 301. In this case, the cured resin member 351 maintains the shape of the inclined portion 309 formed in the electric connection portion 302 of the electric wiring substrate 301.

As explained above, according to the second embodiment, the reliability of the portion where the element substrate 201 and the electric wiring substrate 301 are electrically connected to each other can be improved as in the first embodiment.

Moreover, in the second embodiment, the inclined portion 309 extending while being inclined in the opposite direction to the end portion region 228 is formed in the portion (electric connection portion 302) of the electric wiring substrate 301 where the facing region 304 facing the end portion region 228 is provided. This allows the electric connection portion 302 of the electric wiring substrate 301 to come into contact with the electrode terminals 222 before coming into contact with the insulating member 226 in the step of bringing the electric wiring substrate 301 close to the element substrate 201 also in the case where the insulating member 226 is thicker than the electrode terminals 222.

### Third Embodiment

Next, a third embodiment is explained. Since individual members in the third embodiment have configurations similar to those in the first embodiment described above, the individual members are explained while being denoted by the same signs as the members in the first embodiment described above. The liquid ejection head 120 according to the third embodiment is configured similarly to the liquid ejection head 120 according to the first embodiment except for the shape of the insulating member 226. Explanation of portions of the third embodiment in common with the first embodiment is omitted as appropriate.

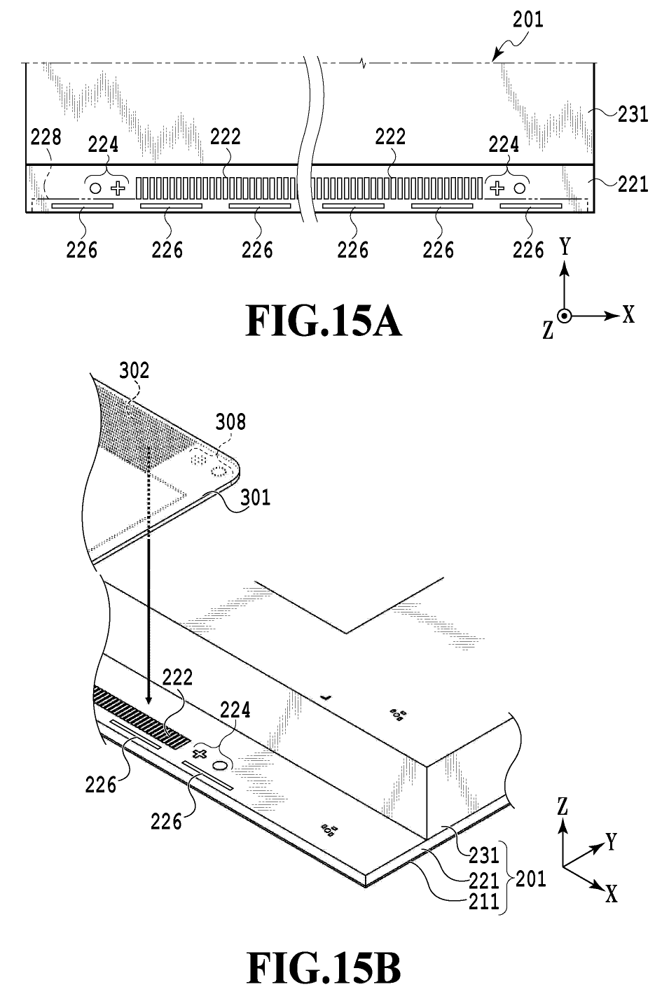

FIGS. 15A and 15B are diagrams for explaining the element substrate 201 in the third embodiment. FIG. 15A is an enlarged diagram illustrating an area near a -Y direction side end of the element substrate 201. FIG. 15B is an enlarged diagram illustrating a state where the element substrate 201 and the electric wiring substrate 301 are separated from each other.

As illustrated in FIGS. 15A and 15B, multiple insulating members 226 are formed in the end portion region 228 in the element substrate 201 (actuator substrate 221) of the third embodiment. The multiple insulating members 226 are arranged to be aligned along the end portion of the element substrate 201 (actuator substrate 221). The insulating members 226 of the third embodiment are formed to linearly extend along the end portion of the element substrate 201 (actuator substrate 221). The insulating members 226 of the third embodiments are shorter than the insulating member 226 of the first embodiment, and gaps are formed in the multiple insulating members 226. Note that the size and the number of insulating members 226 are selected as appropriate. For example, the thickness of the insulating members 226 may be 10 μm or less and 2 μm or more. Moreover, the width of the insulating members 226 in the Y direction (direction from the electrode terminals 222 toward the end portion of the actuator substrate 221) may be 100 μm or less.

The liquid ejection head 120 and the liquid ejection apparatus 100 according to the third embodiment are manufactured by a manufacturing method similar to that in the first embodiment. Accordingly, explanation relating to the manufacturing method in the third embodiment is omitted.

In the third embodiment, the multiple insulating members 226 aligned along the end portion of the element substrate 201 are arranged between the end portion region 228 in the element substrate 201 and the facing region 304 in the wiring portion 321 of the electric wiring substrate 301. As in the first embodiment, the multiple insulating members 226 formed on the actuator substrate 221 make the wiring portion 321 of the electric wiring substrate 301 less likely to come into contact with the actuator substrate 221. This can suppress the case where the wiring portion 321 of the electric wiring substrate 301 comes into contact with the actuator substrate 221 in the element substrate 201, and causes contact failure or the like in the case where the element substrate 201 and the electric wiring substrate 301 are electrically connected to each other. Moreover, since part of the pre-cured resin member 351 spreading on the element substrate 201 passes through the gaps of the multiple insulating members 226 in the case where the electric wiring substrate 301 is connected to the element substrate 201, a filling performance of the resin member 351 can be improved. Furthermore, a performance of discharging of gas included in the pre-cured resin member 351 can be improved, and a performance of discharging air bubbles generated by volatilization of a solvent or the like in curing of the resin member 351 can be improved. Accordingly, the reliability of the portion where the element substrate 201 and the electric wiring substrate 301 are electrically connected to each other can be improved.

As explained above, according to the third embodiment, the reliability of the portion where the element substrate 201 and the electric wiring substrate 301 are electrically connected to each other can be improved as in the first embodiment.

Moreover, in the third embodiment, in the end portion region 228 of the element substrate 201, the multiple insulating members 226 aligned along the end portion of the element substrate 201 are arranged between the end portion region 228 and the electric wiring substrate 301. This causes part of the pre-cured resin member 351 spreading on the element substrate 201 to pass through the gaps of the multiple insulating members 226 in the case where the electric wiring substrate 301 is connected to the element substrate 201, and the filling performance of the resin member 351 can be improved. Moreover, the performance of discharging of gas included in the pre-cured resin member 351 can be improved, and the performance of discharging air bubbles generated by volatilization of a solvent or the like in curing of the resin member 351 can be improved.

In the above-mentioned third embodiment, the inclined portion 309 extending while being inclined in the opposite direction to the end portion region 228 may be formed in the portion (electric connection portion 302) of the electric wiring substrate 301 where the facing region 304 is provided, as in the second embodiment. This allows the electric connection portion 302 of the electric wiring substrate 301 to come into contact with the electrode terminals 222 before coming into contact with the insulating members 226 in the step of brining the electric wiring substrate 301 close to the element substrate 201 also in the case where the insulating members 226 are thicker than the electrode terminals 222.

### Fourth Embodiment

Next, a fourth embodiment is explained. Since individual members in the fourth embodiment have configurations similar to those in the first embodiment described above, the individual members are explained while being denoted by the same signs as the members in the first embodiment described above. The liquid ejection head 120 according to the fourth embodiment is configured similarly to the liquid ejection head 120 according to the first embodiment except for the shape of the insulating member 226. Explanation of portions of the fourth embodiment in common with the first embodiment is omitted as appropriate.

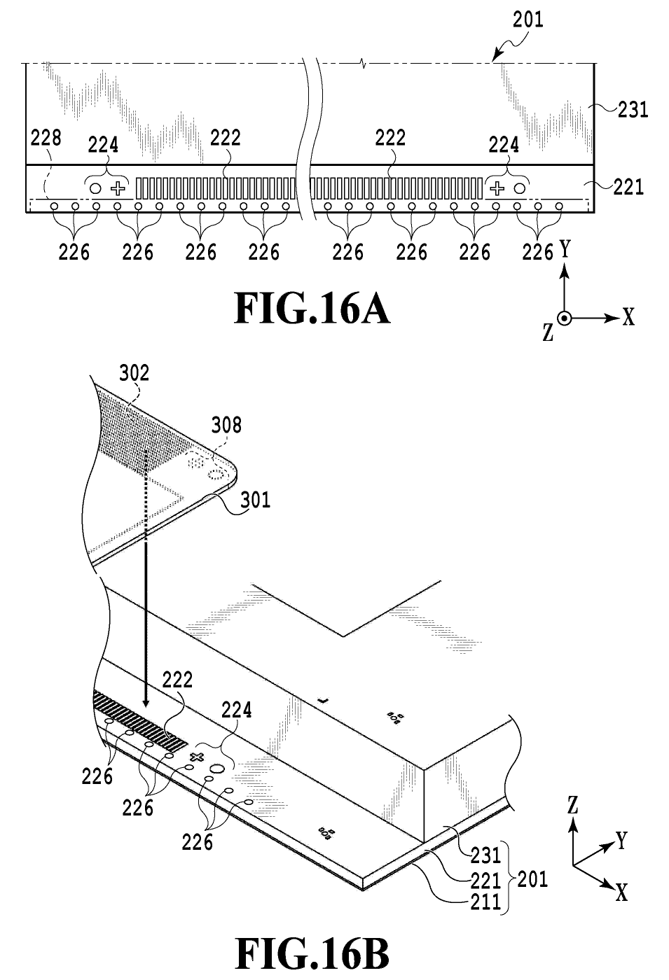

FIGS. 16A and 16B are diagrams for explaining the element substrate 201 in the fourth embodiment. FIG. 16A is an enlarged diagram illustrating an area near a -Y direction side end of the element substrate 201. FIG. 16B is an enlarged diagram illustrating a state where the element substrate 201 and the electric wiring substrate 301 are separated from each other.

As illustrated in FIGS. 16A and 16B, multiple insulating members 226 are formed in the end portion region 228 in the element substrate 201 (actuator substrate 221) of the fourth embodiment. The multiple insulating members 226 are arranged to be aligned along the end portion of the element substrate 201 (actuator substrate 221). The insulating members 226 of the fourth embodiment are formed in a dot shape. The insulating members 226 of the fourth embodiment are smaller than the insulating member 226 of the first embodiment, and gaps are formed in the multiple insulating members 226. Note that the size and the number of insulating members 226 are selected as appropriate. For example, the thickness of the insulating members 226 may be 10 μm or less and 2 μm or more. Moreover, the width of the insulating members 226 in the Y direction (direction from the electrode terminals 222 toward the end portion of the actuator substrate 221) may be 100 μm or less.

The liquid ejection head 120 and the liquid ejection apparatus 100 according to the fourth embodiment are manufactured by a manufacturing method similar to that in the first embodiment. Accordingly, explanation relating to the manufacturing method in the fourth embodiment is omitted.

In the fourth embodiment, the multiple insulating members 226 aligned along the end portion of the element substrate 201 are arranged between the end portion region 228 in the element substrate 201 and the facing region 304 in the wiring portion 321 of the electric wiring substrate 301. As in the first embodiment, the multiple insulating members 226 formed on the actuator substrate 221 makes the wiring portion 321 of the electric wiring substrate 301 less likely to come into contact with the actuator substrate 221. This can suppress the case where the wiring portion 321 of the electric wiring substrate 301 comes into contact with the actuator substrate 221 in the element substrate 201, and causes contact failure or the like in the case where the element substrate 201 and the electric wiring substrate 301 are electrically connected to each other. Moreover, since part of the pre-cured resin member 351 spreading on the element substrate 201 passes through the gaps of the multiple insulating members 226 in the case where the electric wiring substrate 301 is connected to the element substrate 201, a filling performance of the resin member 351 can be improved. Furthermore, a performance of discharging gas included in the pre-cured resin member 351 can be improved, and a performance of discharging air bubbles generated by volatilization of a solvent or the like in curing of the resin member 351 can be improved. Accordingly, the reliability of the portion where the element substrate 201 and the electric wiring substrate 301 are electrically connected to each other can be improved.

The same material as the resin member 351 or a material close to the resin member 351 is used for the insulating members 226 in consideration of electric reliability, compatibility with the resin member 351, commonizing of material, and the like. The resin member 351 is discharged from contact surfaces between the electrode terminals 222 of the element substrate 201 and the wiring portion 321 of the electric wiring substrate 301 in the case where the electric wiring substrate 301 is connected to the element substrate 201. Accordingly, a highly-fluid material in which addition of solid bodies is small is used for the resin member 351. In the case where the insulating members 226 are formed by using the same highly-fluid material as the resin member 351, maintaining the shapes of the pre-curing insulating members 226 constant is sometimes difficult. In the fourth embodiment, since the insulating members 226 are formed in the dot shape, an application amount of the pre-cured insulating members 226 can be suppressed to minimum. This reduces variation in the shapes of the pre-cured insulating members 226 from that in the case where the insulating members 226 are formed to linearly extend, and the shapes of the insulating members 226 can be stabilized.

As explained above, according to the fourth embodiment, the reliability of the portion where the element substrate 201 and the electric wiring substrate 301 are electrically connected to each other can be improved as in the first embodiment.

Moreover, in the fourth embodiment, in the end portion region 228 of the element substrate 201, the multiple insulating members 226 aligned along the end portion of the element substrate 201 are arranged between the end portion region 228 and the electric wiring substrate 301. This causes part of the pre-cured resin member 351 spreading on the element substrate 201 to pass through the gaps of the multiple insulating members 226 in the case where the electric wiring substrate 301 is connected to the element substrate 201, and the filling performance of the resin member 351 can be improved. Moreover, the performance of discharging gas included in the pre-cured resin member 351 can be improved, and the performance of discharging air bubbles generated by volatilization of a solvent or the like in curing of the resin member 351 can be improved.

In the fourth embodiment, the insulating members 226 are formed in the dot shape. Since this can suppress the application amount of the pre-cured insulating members 226 to minimum, the variation in the shapes of the pre-cured insulating members 226 is reduced, and the shapes of the insulating members 226 can be stabilized.

In the above-mentioned fourth embodiment, the inclined portion 309 extending while being inclined in the opposite direction to the end portion region 228 may be formed in the portion (electric connection portion 302) of the electric wiring substrate 301 where the facing region 304 is provided, as in the second embodiment. This allows the electric connection portion 302 of the electric wiring substrate 301 to come into contact with the electrode terminals 222 before coming into contact with the insulating members 226 in the step of brining the electric wiring substrate 301 close to the element substrate 201 also in the case where the insulating members 226 are thicker than the electrode terminals 222.

### Modified Example

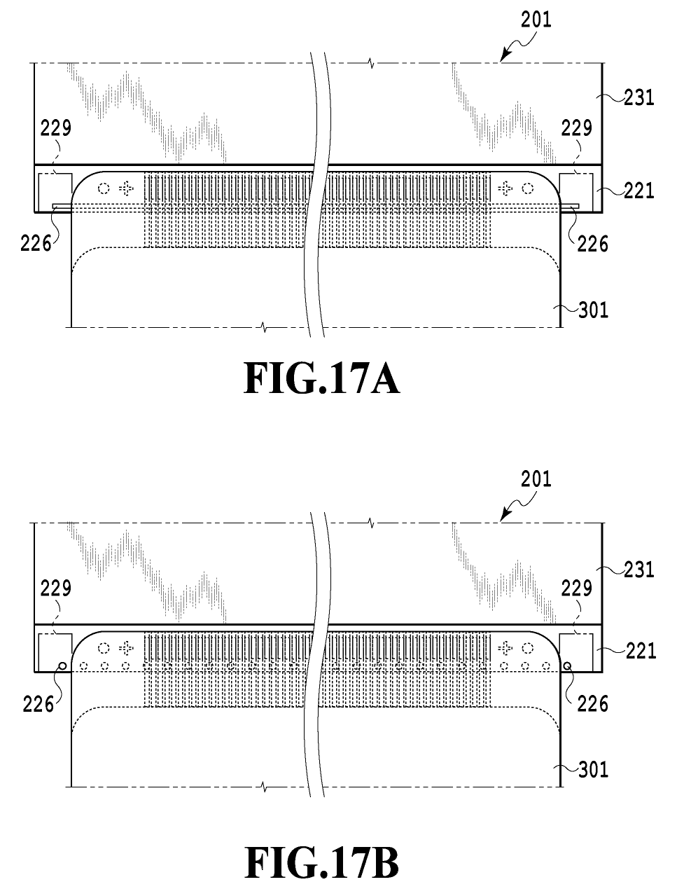

FIGS. 17A and 17B are schematic diagrams illustrating a modified example of the liquid ejection unit 200. FIG. 17A is as schematic diagram illustrating a modified example of the liquid ejection unit 200 in the first and second embodiments. In the above-mentioned first and second embodiments, the insulating member 226 may be arranged in portions not overlapping the electric wiring substrate 301 in a view in a direction perpendicular to the surface of the element substrate 201. Specifically, a preliminary formation region 229 in which part of the insulating member 226 is formed may be provided in a region of the element substrate 201 (actuator substrate 221) that does not overlap the electric wiring substrate 301. Note that, in the element substrate 201 (actuator substrate 221), at least part of the preliminary formation region 229 may overlap a portion of the end portion region 228 that does not overlap the electric wiring substrate 301. In the case where application of the insulating member 226 is started, first, the pre-cured insulating member 226 is applied to the preliminary formation region 229 in the element substrate 201. Even if initial ejection failure occurs in the coating machine, the initial ejection failure affects a portion of the insulating member 226 applied to the preliminary formation region 229 in the insulating member 226 linearly extending along the end portion of the element substrate 201. Accordingly, it is possible to suppress the case where the shape of the insulating member 226 arranged between the end portion region 228 in the element substrate 201 and the facing region 304 in the wiring portion 321 of the electric wiring substrate 301 becomes unstable, even if the initial ejection failure occurs in the coating machine.

FIG. 17B is a schematic diagram illustrating a modified example of the liquid ejection unit 200 in the fourth embodiment. In the above-mentioned fourth embodiment, the insulating members 226 may be arranged in a portion not overlapping the electric wiring substrate 301 in the view in the direction perpendicular to the surface of the element substrate 201. Specifically, a preliminary formation region 229 in which some of the multiple insulating members 226 are formed may be provided in a region of the element substrate 201 (actuator substrate 221) that does not overlap the electric wiring substrate 301. Note that, in the element substrate 201 (actuator substrate 221), at least part of the preliminary formation region 229 may overlap a portion of the end portion region 228 that does not overlap the electric wiring substrate 301. In the case where application of the insulating member 226 is started, first, the pre-cured insulating member 226 is applied to the preliminary formation region 229 in the element substrate 201. Even if initial ejection failure occurs in the coating machine, the initial ejection failure affects the insulating member 226 applied to the preliminary formation region 229 among the multiple insulating members 226 aligned along the end portion of the element substrate 201. Accordingly, it is possible to suppress the case where the shapes of the insulating members 226 arranged between the end portion region 228 in the element substrate 201 and the facing region 304 in the wiring portion 321 of the electric wiring substrate 301 become unstable, even if the initial ejection failure occurs in the coating machine.

Moreover, in the above-mentioned third embodiment, the insulating members 226 may be arranged in portions not overlapping the electric wiring substrate 301 in the view in the direction perpendicular to the surface of the element substrate 201. Specifically, a preliminary formation region in which some of the multiple insulating members 226 are formed may be provided in a region of the element substrate 201 (actuator substrate 221) that does not overlap the electric wiring substrate 301. As in the above-mentioned modified example, it is possible to suppress the case where the shapes of the insulating members 226 arranged between the end portion region 228 in the element substrate 201 and the facing region 304 in the wiring portion 321 of the electric wiring substrate 301 become unstable, even if the initial ejection failure occurs in the coating machine.

Although the examples to which the technique of the present disclosure can be applied have been explained above, the technical scope of the present disclosure is not limited to the examples described above. The first embodiment, the second embodiment, the third embodiment, and the fourth embodiment may be combined as appropriate.

In the above-mentioned embodiments, the order of performing the steps in the manufacturing process of the liquid ejection apparatus 100 is not limited as long as the manufacturing of the liquid ejection apparatus 100 is possible. The order of performing the steps in the manufacturing process of the liquid ejection apparatus 100 may be changed as appropriate. Some of the steps in the manufacturing process of the liquid ejection apparatus 100 may be simultaneously performed.

In the above-mentioned embodiments, the inks are used as the liquid. However, the liquid to which the technique of the present disclosure can be applied is not limited to the inks. For example, a processing liquid or the like used to improve a fixing property of an ink on a print medium, reduce glossy unevenness, or improve scratch resistance may be used as the liquid.

In the above-mentioned embodiments, the cut sheet is given as an example of the print medium P. However, the print medium P is not limited to the cut sheet as long as the liquid can be applied to the print medium P. Other examples of the print medium P include continuous roll paper, plastic, film, fabric, metal, flexible board, and the like.

In the above-mentioned embodiments, the electrode terminals 222 are provided along the two opposite sides of the element substrate 201. However, the electrode terminals 222 may be provided along four sides of the element substrate 201. In this case, four electric wiring substrates 301 are connected to four end portions of the element substrate 201. This can increase the number of electrode terminals 222, and increase the density of the ejection ports 212 corresponding to the electrode terminals 222. Increasing the density of the ejection ports 212 allows high print quality to be maintained also in the case where an image is printed at high speed.

In the above-mentioned embodiments, the piezoelectric elements are given as the example of the energy generation elements. However, the energy generation elements are not limited to the piezoelectric elements as long as the energy generation elements can apply energy necessary for ejection to the liquid. Other examples of the energy generation elements include electrothermal transducing elements. For example, the liquid may be ejected from the ejection ports by heating the liquid and generating air bubbles by using heaters as the electrothermal transducing elements. The technique of the present disclosure can be applied also to a liquid ejection unit of a so-called thermal method as described above.

In the above-mentioned embodiments, the liquid ejection head 120 is a so-called page wide type liquid ejection head. However, the liquid ejection head 120 may be a liquid ejection head that performs printing while performing scanning. The technique of the present disclosure can be applied also to a so-called serial liquid ejection head as described above.

In the above-mentioned embodiments, the four liquid ejection units 200 are arranged in staggered arrangement on the common support member 123. However, the configuration is not limited to this. For example, one liquid ejection unit 200 may be arranged on the common support member 123.

In the above-mentioned embodiments, the electric wiring substrate 301 to which no resin member 351 is applied is connected to the element substrate 201 to which the resin member 351 is applied. However, the configuration is not limited to this. For example, the electric wiring substrate 301 to which the resin member 351 is applied may be connected to the element substrate 201 to which no resin member 351 is applied. To which one of the element substrate and the electric wiring substrate the resin member is applied can be selected as appropriate depending on the configuration of the liquid ejection apparatus.

In the above-mentioned embodiments, the resin member 351 is formed by using the non-conductive resin. However, the configuration is not limited to this. For example, the resin member 351 may be formed by using an anisotropic conductive film (ACF). Moreover, for example, the electric wiring substrate 301 may be connected to the element substrate 201 by forming gold bumps on the electrode terminals 222 and joining the electrode terminals 222 of the element substrate 201 and the electric connection portion 302 of the electric wiring substrate 301 to one another by using ultrasonic wave, heat, or the like. In this case, the electric wiring substrate 301 can be connected to the element substrate 201 without use of the resin member 351.

In the above-mentioned embodiments, in the case where the electric wiring substrate 301 is brought close to the element substrate 201, the bonding tool 500 holds the electric wiring substrate 301 parallel to the element substrate 201. However, the configuration is not limited to this. For example, in the step of bringing the electric wiring substrate 301 close to the element substrate 201, the bonding tool 500 may hold the electric wiring substrate 301 such that a base end portion of the electric wiring substrate 301 is inclined in a direction away from the element substrate 201. Moreover, in the step of connecting the electric wiring substrate 301 to the element substrate 201, the bonding tool 500 may change the orientation of the electric wiring substrate 301 such that the electric wiring substrate 301 is parallel to the element substrate 201. This can suppress the case where the wiring portion 321 of the electric wiring substrate 301 comes into contact with the actuator substrate 221 in the element substrate 201, and causes contact failure or the like in the case where the element substrate 201 and the electric wiring substrate 301 are electrically connected to each other.

In the above-mentioned embodiments, the wiring portion 321 of the electric wiring substrate 301 and the electrode terminals 222 of the element substrate 201 are connected to one another. However, the configuration is not limited to this. For example, a terminal portion formed to be connected to the wiring portion of the electric wiring substrate and the electrode terminals 222 of the element substrate 201 may be connected to one another.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the present disclosure, the reliability of the portion where the element substrate and the electric wiring substrate are electrically connected to each other can be improved.

This application claims the benefit of Japanese Patent Application No. 2025-012936, filed January 29, 2025, which is hereby incorporated by reference herein in its entirety.

What is claimed is:

1. A liquid ejection head, comprising:
an element substrate including an electrode terminal; and
an electric wiring substrate including a wiring portion electrically connected to the electrode terminal, wherein
the electrode terminal is arranged in an end portion of the element substrate, and
in an end portion region between the electrode terminal in the element substrate and an end portion of the element substrate, an insulating member is arranged between the end portion region and the electric wiring substrate.

2. The liquid ejection head according to claim 1, further comprising a resin member configured to maintain a state where the electrode terminal and the wiring portion are electrically connected to each other.

3. The liquid ejection head according to claim 2, wherein the resin member is formed by using a non-conductive resin, and is arranged around the electrode terminal.

4. The liquid ejection head according to claim 3, wherein the insulating member is formed by using the non-conductive resin.

5. The liquid ejection head according to claim 2, wherein
a portion of the electric wiring substrate where a facing region facing the end portion region is provided includes an inclined portion extending while being inclined in an opposite direction to the end portion region, and
the resin member maintains a shape of the inclined portion.

6. The liquid ejection head according to claim 1, wherein the insulating member is formed in the end portion region.

7. The liquid ejection head according to claim 6, wherein a thickness of the insulating member is 10 μm or less.

8. The liquid ejection head according to claim 6, wherein a width of the insulating member is 100 μm or less.

9. The liquid ejection head according to claim 6, wherein the insulating member is arranged also in a portion not overlapping the electric wiring substrate in a view in a direction perpendicular to a surface of the element substrate.

10. The liquid ejection head according to claim 1, wherein, in the end portion region, a plurality of the insulating members aligned along the end portion of the element substrate are arranged between the end portion region and the electric wiring substrate.

11. The liquid ejection head according to claim 10, wherein the insulating members are formed to linearly extend along the end portion of the element substrate.

12. The liquid ejection head according to claim 10, wherein the insulating members are formed in a dot shape.

13. The liquid ejection head according to claim 1, wherein the element substrate includes an energy generation element configured to be supplied with power from the electrode terminal and generate energy for ejecting liquid.

14. A manufacturing method of a liquid ejection head including: an element substrate including an electrode terminal; and an electric wiring substrate including a wiring portion electrically connected to the electrode terminal, wherein the electrode terminal is arranged in an end portion of the element substrate, the manufacturing method comprising:
forming an insulating member in an end portion region between the electrode terminal in the element substrate and an end portion of the element substrate; and
connecting the wiring portion of the electric wiring substrate to the electrode terminal of the element substrate.

15. The manufacturing method of the liquid ejection head according to claim 14, wherein, in the connecting the wiring portion of the electric wiring substrate to the electrode terminal of the element substrate, a connection region of the wiring portion to be connected to the electrode terminal is pressed against the electrode terminal by using a bonding tool configured to hold the electric wiring substrate by causing the electric wiring substrate to adhere to the bonding tool.

16. The manufacturing method of the liquid ejection head according to claim 15, wherein, in the connecting the wiring portion of the electric wiring substrate to the electrode terminal of the element substrate, an inclined portion extending while being inclined in an opposite direction to the end portion region is formed in a portion of the electric wiring substrate adhering to and held by the bonding tool, the portion being a portion where a facing region facing the end portion region is provided.

17. The manufacturing method of the liquid ejection head according to claim 16, further comprising
applying a resin member to the electrode terminal of the element substrate; and
curing the resin member spread around the electrode terminal in the connecting the wiring portion of the electric wiring substrate to the electrode terminal of the element substrate, wherein
the cured resin member maintains a shape of the inclined portion.
